(19) United States
(12) Patent Application Publication
(10) Pub. No.: US 2005/0182791 A1
(43) Pub. Date: Aug. 18, 2005

(54) Method and system for multimedia consumption based on user terminal characteristics and recording medium thereof

(75) Inventors: Jeongyeon Lim, Daejeon (KR); Munchurl Kim, Daejeon (KR)

Correspondence Address: BACON & THOMAS, PLLC, 625 SLATERS LANE, FOURTH FLOOR, ALEXANDRIA, VA, 22314, US

(73) Assignee: Information and Communications University Educational Foundation, Seoul (KR)

(21) Appl. No.: 10/986,320

(22) Filed: Nov. 12, 2004

(30) Foreign Application Priority Data
Nov. 11, 2003 (KR) 10-2003-0079335

(51) Int. Cl. G06F 17/00

(52) U.S. Cl. 707/104.1

(57) ABSTRACT

The present invention relates to a method and a system for a multimedia consumption based on user characteristics and user's terminal characteristics and a recording medium thereof. The present invention includes a user information terminal for transmitting context metadata manually set and/or automatically computed at a user information terminal for consuming multimedia contents via a network; a display terminal for parsing the transmitted context metadata, transmitting the content request data and context metadata to a content server and then receiving, decoding and displaying the multimedia data adapted in response to the transmission; and a content server system for creating adaptation contents by adapting original contents based on the received metadata and then transmitting the created adaptation contents via a network.

### FIELD OF INVENTION

The present invention relates to a method and a system for a multimedia consumption based on user terminal characteristics and a recording medium thereof; and, more particularly, to a method and a system enabling a improved multimedia consumption by way of rendering multimedia contents to a display terminal in a multimedia environment which uses various user terminals, and a recording medium thereof.

### BACKGROUND OF THE INVENTION

Generally, a multimedia content service is provided to a user through ultra-high-speed Internet. In addition to conventional services such as a voice message service and a short message service, various multimedia related contents requiring a large bandwidth are transmitted to clients due to an improved wireless bandwidth.

Such multimedia content service employs a server-client type in which contents collected by content providers are transformed and compressed into a form suitable for a service and then shared by multiple subscribers through streaming server.

Further, a display terminal is needed so that a user is able to directly check and see the multimedia content service. However, the display terminal only provides specific multimedia contents suitable for its device specification. Accordingly, if a standard of the display terminal is not matched therewith, the multimedia content service cannot be rendered on the display terminal.

Furthermore, for a future's flexible multimedia environment, there would be demands for a service type and a management and transmission method describing user status and content status to provide a multimedia mobility enabling a seamless consumption of multimedia contents on any device in a mobile environment.

### SUMMARY OF THE INVENTION

It is, therefore, an objective of the present invention to provide a method and a system for a multimedia consumption based on user characteristics and user's terminal characteristics, which enable an improved multimedia consumption by way of rendering multimedia contents to a display terminal under a multimedia environment which uses various user terminals, and a recording medium thereof.

In accordance with an aspect of the invention, there is provided a system for a multimedia consumption based on user characteristics and user's terminal characteristics, the system including: a user information terminal for transmitting context metadata manually and/or automatically created at a user information terminal to a content server for consuming multimedia contents via a network; a display terminal for parsing the transmitted context metadata, transmitting the parsed metadata to a content server and then receiving, decoding and displaying the multimedia data adapted in response to the transmission; and a content server system for generating adaptation contents by adapting original contents based on the received metadata and then transmitting the generated adaptation contents via a network.

In accordance with another aspect of the invention, there is provided a method for a multimedia consumption based on user characteristics and user's terminal characteristics, the method including the steps of: (a) transmitting context metadata manually and/or automatically created at a user information terminal for consuming multimedia contents via a network; (b) parsing the transmitted context metadata and then transmitting the parsed metadata to a content server; (c) creating adaptation contents by adapting original contents based on the transmitted metadata and then transmitting the created adaptation contents via a network; and (d) receiving the adapted multimedia contents and then decoding and displaying the received multimedia contents.

### BRIEF DESCRIPTION OF THE DRAWINGS

The above and other objectives and features of the present invention will become apparent from the following description of preferred embodiments, given in conjunction with the accompanying drawings, in which:

FIG. 1 shows a block diagram of a system for a multimedia consumption based on user characteristics and user's terminal characteristics in accordance with a preferred embodiment of the present invention; and

FIGS. 2A, 2B and 2C describe flowcharts illustrating a process of a method for a multimedia consumption based on user characteristics and user's terminal characteristics in accordance with a preferred embodiment of the present invention.

### DETAILED DESCRIPTION OF THE PREFERRED EMBODIMENT

Hereinafter, preferred embodiments of the present invention will be described in detail with reference to the accompanying drawings.

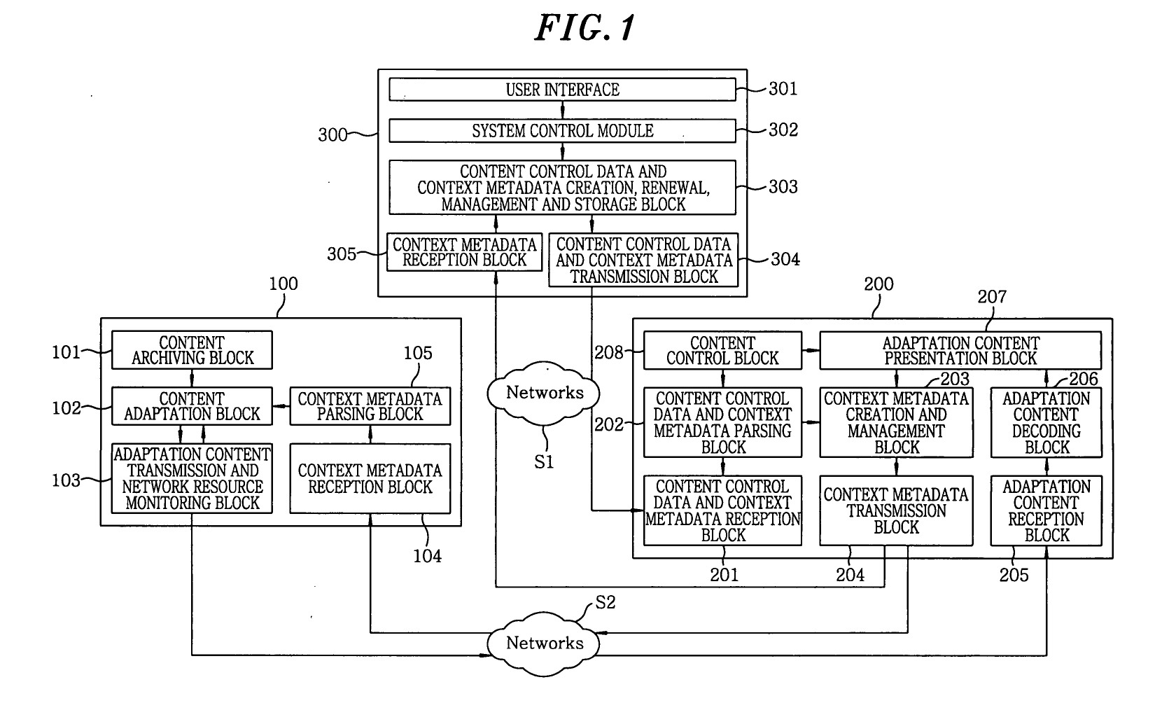

FIG. 1 shows a block diagram of a system for a multimedia consumption based on user characteristics and user's terminal characteristics in accordance with a preferred embodiment of the present invention, wherein the system includes a content server system 100, a display terminal 200 and a user information terminal 300.

The content server system 100, which is a block for creating adaptation contents by adapting original contents based on context metadata in response to a content service request message containing context information requested from the display terminal 200 and then transmitting the created adaptation contents to the display terminal 200 through a network S2, includes a content archiving block 101, a content adaptation block 102, an adaptation content transmission and network resource monitoring block 103, a context metadata reception block 104 and a context metadata parsing block 105.

The content archiving block 101 includes a database for storing therein contents and a device for reading, storing and renewing the stored contents.

The content adaptation block 102 extracts the contents requested by a user from the content archiving block 101 in response to an analysis result provided from the context metadata parsing block 105 and then provides adaptation contents obtained by transforming contents in accordance with context information to the adaptation content transmission and network resource monitoring block 103. Herein, the content adaptation block 102 can create transformed contents from original contents by considering user characteristics, bandwidth resources of a network, display terminal characteristic information, consumption records for contents requested by a user, computing resource limits or the likes.

Herein, the user characteristics, which refer to a contents consumption history and consumption states, include a user's preference for contents, such as genres, performers, channels, watching hours, personal profiles, consumption prices of watched contents, main time slots of a contents consumption, contents consumption types or the likes.

Further, the user characteristics are context metadata stored in a user information terminal to allow a content user to constantly consume contents being consumed in another terminal. The context metadata indicates information on identification numbers and titles of contents being consumed, consumption degrees, contents consumption prices, contents consumption types or the likes.

Moreover, the user characteristics are also context metadata transmitted to a display terminal for consuming multimedia contents to allow a content user to continuously consume contents being consumed in another terminal. The context metadata indicates information on a display terminal in which a user desires to consume contents, such as a display size, a color depth, codec characteristics, characteristics of a power supply system (a battery life, a normal power supply connection or disconnection), a network environment, an execution environment of an operating system.

The display terminal characteristic information represents characteristic information on a bandwidth of a network to which a display terminal for displaying contents is connected, the number of users connected to the content server, a display terminal size, a color depth, codec characteristics, a battery life, an operating system and a program execution environment.

The adaptation content transmission and network resource monitoring block 103 transforms (modulates) contents adapted based on information provided from the content adaptation block 102 into wired or wirelessly transmittable signal data and then transmits them to the adaptation content reception block 205 in the display terminal 200 via a wired and/or wireless network S2, the information being on the user characteristics, the bandwidth resources of a network, the display terminal, the consumption records for contents requested by a user, computing resource limits or the likes. Further, in case a request of the content adaptation block is checked by monitoring the network resources, network status information (a bandwidth, a delay or the likes) is provided to the content adaptation block 102.

The context metadata reception block 104 provides the context metadata received from the display terminal 200 via the network S2 to the context metadata parsing block 105, the context metadata containing information on the user characteristics, the display terminal characteristics, the user's contents consumption records or the likes.

The context metadata parsing block 105 analyzes the context metadata provided from the context metadata reception block 104 and then provides the analysis result to the content adaptation block 102.

The display terminal 200 corresponding to a wired terminal (e.g., a computer, a TV set or the likes having a wire network connection unit) or a wireless terminal (e.g., a PDA, a smart phone, a computer, a TV set or the likes having a wireless network connection unit) is composed of a content control data and context metadata reception block 210, a content control data and context metadata parsing block 202, a context metadata creation and management block 203, a context metadata transmission block 204, an adaptation content reception block 205, an adaptation content decoding block 206, an adaptation content presentation block 207 and a content control block 208.

The content control data and context metadata reception block 201 receives content control data or context metadata from the user information display 300 and then provides it to the content control data and context metadata parsing block 202.

The content control data and context metadata parsing block 202 analyzes the content control data provided from the content control data and context metadata reception block 201 or the context metadata containing user's contents consumption records. Thereafter, if the information received via the network S1 is the content control data, it is provided to the content control block 208. On the other hand, if it is the context information, the received information is provided to the context metadata creation and management block 203.

The context metadata creation and management block 203 stores and manages the content control data and the context metadata provided from the context metadata parsing block 202 and provides the stored context metadata to the context metadata transmission block 204 if necessary. Herein, the context metadata refers to information on a user's restricted profile, a user's preference, and consumption records for watched contents, content consumption status, user environment characteristics, or the likes.

Further, the context metadata creation and management block 203 executes contents requested from the user information terminal 300 to the adaptation content presentation block 207. Further, context information of the simultaneously reproduced contents is stored in a memory (not shown) of the user information terminal 300 and then managed. Herein, the context metadata refers to information on content characteristics such as titles, genres, performers, program hours of contents or the likes.

Besides, The context metadata creation and management block 203 stores and manages metadata containing user terminal information in a memory. Further, in case a specific content is requested from the user information terminal 300, context metadata corresponding to the request is extracted from the memory and then provided to the context metadata transmission block 204.

The context metadata transmission block 204 transforms (modulates) the context metadata provided from the context metadata creation and management block 203 into wirely or wirelessly transmittable signals and then transmits the signals to the context metadata reception block 104 in the content server system 100 via a network S2. Further, the context metadata transmission block 204 provides adaptation content metadata received from the context metadata creation and management block 203 to the user information terminal 300 via the network S1. Herein, the networks S1 and S2 can be a wired network including Internet or a wired/wireless network including a mobile communication network and Internet.

The adaptation content reception block 205 receives adaptation contents from the adaptation content transmission and network resource monitoring block 103 via the network S2 and then provides them to the adaptation content decoding block 206.

The adaptation content decoding block 206 inverse-transforms (demodulates) the adaptation contents into original contents that has existed before the transformation (modulation) so that they can be transmitted, wherein the adaptation contents have been adapted based on the information on the user characteristics, the bandwidth resources of a network, the display terminal characteristics, the consumption records for contents requested by a user, the limitation of computing resources or the likes. Such inverse-transformed adaptation contents are respectively executed and then provided to the adaptation content presentation block 207.

The adaptation content presentation block 207 reproduces the adaptation contents so that the user can watch the adaptation contents adapted based on the information on the user characteristics, the bandwidth resources of a network, the display terminal characteristics, the consumption records for contents requested by the user, the computing resource limits or the likes. Further, content characteristic information provided with the adaptation contents is sent to the context metadata creation and management block 203 so as to be created and managed as metadata and then transmitted to the user information terminal 300.

The content control block 208 serving as information having a content control function is branched by the content control data and context metadata parsing block 202. Herein, the control function indicates functions operated by a user interface such as a fast-forward, a rewind, a play, a record of contents or the likes. The content control block 208 transmits such functions to the adaptation content presentation block 207 so that the contents can be reproduced in accordance with an intention of the user.

The user information terminal 300, i.e., a terminal used by the user, inserts user preferences that are manually and/or automatically set at the user information, user control information and user's restricted information into content serve request data and then transmits such data. In addition, the user information terminal 300 is a block for creating a certain preference based on cumulative statistics of content preference information recorded whenever the user consumes multimedia contents and then transmitting the created context metadata to the display terminal 200 via the network S1, the content preference information indicating genres, types, selection preferences, performers, consumption hours of the contents or the likes. Further, the user information terminal 300 includes a user interface 301, a system control module 302, a content control data and context metadata creation, renewal, management and storage block 303, a content control data and context metadata transmission block 304 and a context metadata reception block 305.

The user interface 301, which is a block for an interface with a user, provides control instructions for a content consumption from a user to the system control module 302.

The system control module 302 provides the control instructions for a multimedia contents consumption from the user interface 301 to the content control data and context metadata creation, renewal, management and storage block 303.

The content control data and context metadata creation, renewal, management and storage block 303 stores in a memory (not illustrated) context metadata obtained by analyzing a cumulated user history for control instructions provided from the system control module 302. Then, in case there is a request from a user using the user information terminal 300, the context metadata, the content control instruction or the user information restrictively defined by the user which are stored in the memory, are extracted and then provided to the content control data and context metadata transmission block 304.

The content control data and context metadata transmission block 304 provides the context metadata to the content control data and context metadata reception block 201 in the display terminal 200 via the network S1.

The context metadata reception block 305 provides information on the adaptation contents received from the display terminal 200 via the network S1 to the content control data and context metadata creation, renewal, management and storage block 303.

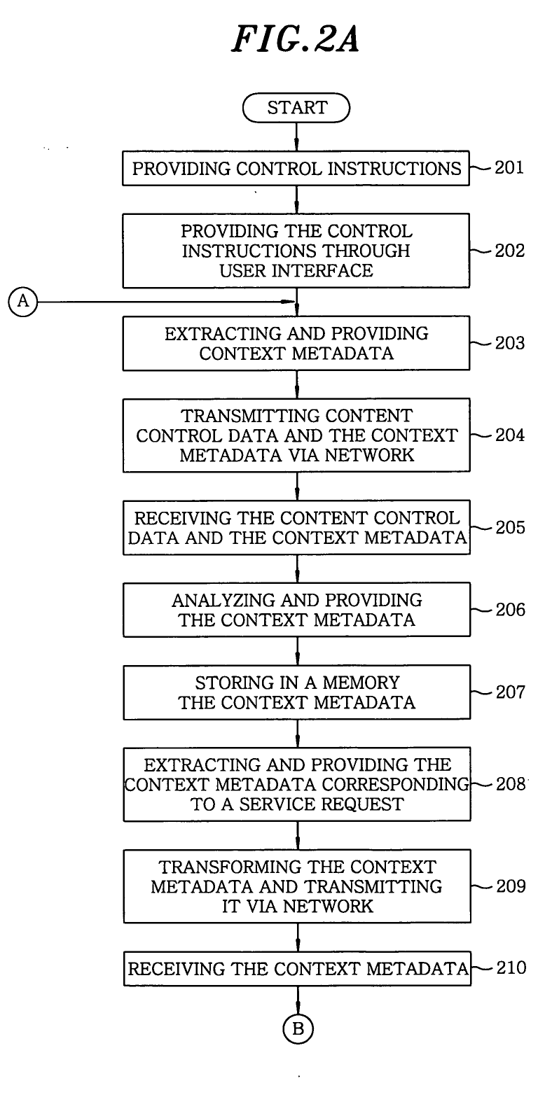

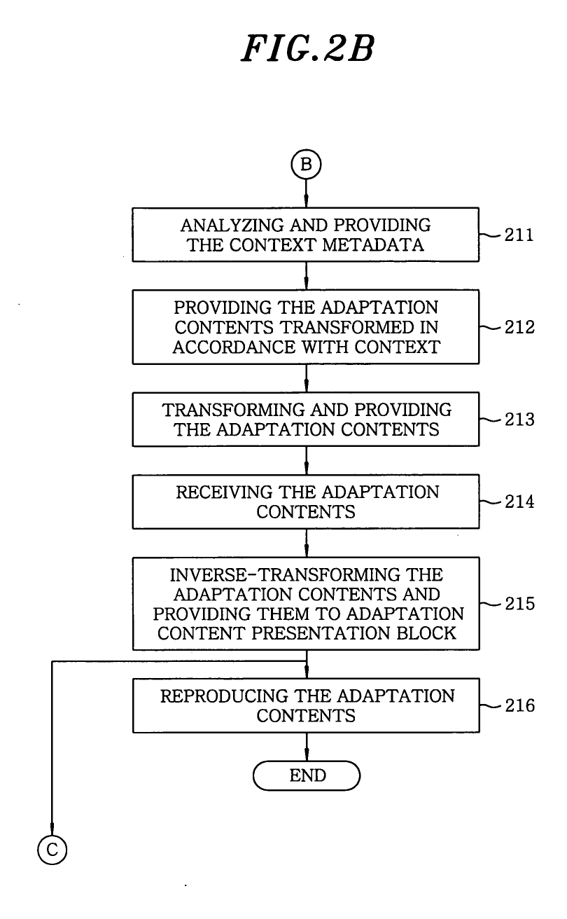

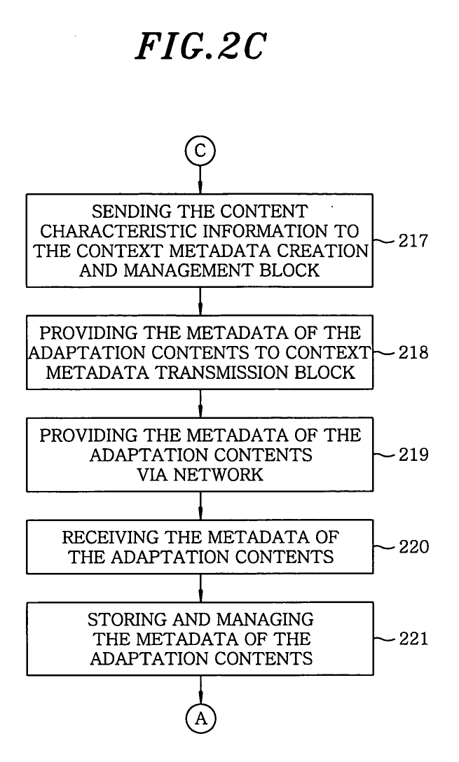

Hereinafter, with reference to a flowchart of FIG. 2, a process of a method for a multimedia consumption based on user characteristics and user's terminal characteristics in accordance with the present invention will be described in detail based on the aforementioned configuration.

First of all, a user provides control instructions for a multimedia contents consumption to the system control module 302 through the user interface 301 in the user information terminal 300 (step 201).

The system control module 302 provides the control instructions for multimedia content consumption through the user interface 301 to the content control data and context metadata creation, renewal, management and storage block 303(step 202).

The content control data and context metadata creation, renewal, management and storage block 303 stores in a memory (not illustrated) context metadata obtained by analyzing a cumulated usage history of content consumption for control instructions provided from the system control module 302. Then, in case there is a request from a user using the user information terminal 300, the context metadata stored in the memory is extracted and then provided to the content control data and context metadata transmission block 304 (step 203).

The content control data and context metadata transmission block 304 provides the context metadata to the content control data and context metadata reception block 201 in the display terminal 200 via the network S1 (step 204).

Herein, the context metadata is transmitted to a new display terminal wirely or wirelessly (Bluetooth, Infrared, Mobile networks, Adhoc networks, WLAN (wireless local area network), WPAN (wireless personal area network)).

The content control data and context metadata reception block 201 receives content control data and context metadata from the content control data and context metadata transmission block 304 in the user information terminal 300 and, then, provides them to the content control data and context metadata parsing block 202 (step 205).

The content control data and context metadata parsing block 202 provides the content control data and the context metadata provided from the content control data and context metadata reception block 201 to the content control block 208 and the context metadata creation and management block 203, respectively. In case of the context metadata, the context metadata containing user's content consumption records and preferences is analyzed and then provided to the context metadata creation and management block 203 together with the context metadata containing metadata for characteristics of a corresponding display terminal (step 206).

The context metadata creation and management block 203 stores in a memory the context metadata provided from the content control data and context metadata parsing block 202 and manages the stored context metadata (step 207).

Further, in case a specific content service is requested from the user information terminal 300 while storing the provided metadata containing information on a user terminal in the memory and managing the stored metadata, the context metadata creation and management block 203 extracts context metadata corresponding to the request from the memory and then provides it to the context metadata transmission block 204 (step 208).

The context metadata transmission block 204 transforms (modulates) the context metadata provided from the context metadata creation and management block 203 into wired or wirelessly transmittable signals and then transmits them to the context metadata reception block 104 in the content server system 100 via the network S2 (step 209).

The context metadata reception block 104 provides to the context metadata parsing block 105 the context metadata received from the context metadata transmission block 204 via the network S2 (step 210), the context metadata containing the information on the user characteristics, the display terminal characteristics, user's contents consumption records or the likes.

The context metadata parsing block 105 analyzes the context metadata provided from the context metadata reception block 104 and then provides the analysis result to the content adaptation block 102 (step 211).

The content adaptation block 102 extracts the contents requested by the user from the content archiving block 101 in response to the analysis result provided from the context metadata parsing block 105 and, further, provides the context information and the adaptation contents to the adaptation content transmission and network resource monitoring block 103, wherein the adaptation contents has been transformed in accordance with the network resources, e.g., a bandwidth, a processing speed or the likes, obtained from the adaptation content transmission and network resource monitoring block 103 (step 212).

The adaptation content transmission and network resource monitoring block 103 transforms (modulates) the adaptation contents provided from the content adaptation block 102 and the adaptation content transmission and network resource monitoring block 103 into wired or wirelessly transmittable signals and then transmits them to the adaptation content reception block 205 (step 213), wherein the adaptation contents have been adapted based on the information on the user characteristics, the bandwidth resources of a network, the display terminal characteristics, the consumption records for contents requested by a user, the computing resource limits or the likes.

The adaptation content reception block 205 receives the adaptation contents transmitted from the adaptation content transmission and network resource monitoring block 103 via the network S2 and then provides the contents to the adaptation content decoding block 206 (step 214).

The adaptation content decoding block 206 inverse-transforms (demodulates) the adaptation contents into original contents that has existed before the encoding (modulation) so that they can be transmitted, wherein the adaptation contents provided from the adaptation content reception block 205 have been adapted based on the information on the user characteristics, the bandwidth resources of a network, the display terminal characteristics, the consumption records for contents requested by a user, the limitation of computing resources or the likes. Thereafter, such inverse-transformed adaptation contents are respectively decoded and then provided to the adaptation content presentation block 207 (step 215).

The adaptation content presentation block 207 reproduces the adaptation contents so that the user can watch the contents adapted based on the information on the user characteristics, the bandwidth resources of a network, the display terminal characteristics, the consumption records for contents requested by the user, the computing resource limits or the likes. Further, the adaptation content presentation block 207 can reproduce the contents controlled by a user's control operation transmitted to the content control block 208 (step 216).

The adaptation content presentation block 207 sends the content characteristic information obtained by the reproduction to the context metadata creation and management block 203 so that the metadata can be created and managed (step 217).

Meanwhile, the context metadata creation and management block 203 creates or corrects as new metadata various contents information on adaptation contents created based on the adaptation contents reproduced by the adaptation content presentation block 207 and, then, provides the metadata to the context metadata transmission block 204 (step 218).

The context metadata transmission block 204 provides the metadata of the adaptation contents, which is provided from the context metadata creation and management block 203, to the context metadata reception block 305 in the user information terminal 300 via the network S2 (step 219).

The context metadata reception block 305 provides the metadata of the adaptation contents, which is received from the display terminal 200 via the network S1, to the content control data and context metadata creation, renewal, management and storage block 303 (step 220).

The content control data and context metadata creation, renewal, management and storage block 303 stores and manages the metadata of the adaptation contents, which is provided from the context metadata reception block 305 (step 221).

Herein, the user information terminal and the display terminal selected by the user are wired or wireless terminals, and the network is a wired network including Internet or a wired/wireless network including Internet, Bluetooth, Infrared, Mobile networks, Adhoc networks, WLAN, WPAN.

Accordingly, in accordance with the present invention, by using the context metadata information, the mobility is provided so that each user can seamlessly consume contents that were being consumed on a previous display terminal 200 in a new display terminal having different terminal characteristics based on the context information of the content. Further, transformed multimedia contents (image/audio/video/text contents), i.e., contents transformed by considering user's interests, limited resources and system information, can desirably be rendered based on contents preferences that are manually se and/or automatically computed on the user information terminal; random contents references automatically extracted based on cumulative statistics about a contents consumption history; and user's personal information. Accordingly, the user's convenience (indicating a general multimedia access) can be improved and, further, user's various service demands can be effectively satisfied.

Furthermore, it is unnecessary to additionally store in the content server system 100 or the display terminal 200 user information of every user who connects by using the method for a multimedia consumption based on a user terminal characteristic in accordance with the present invention. Moreover, there is no additional cost for upgrading the user preferences in a server system or the user information terminal 200.

Moreover, the user information management is performed in the user information terminal 300 and, therefore, the user information can be safely managed only in a user's terminal such as a remote control, a PDA, a cell phone or the likes.

In addition, the system and the method for a multimedia consumption based on user terminal characteristics in accordance with the present invention described with respect to FIGS. 1 and 2 can be implemented into corresponding programs and then stored in a recording medium. The programs stored in the recording medium can be executed in a hardware corresponding to the system of the present invention and a general-purpose hardware.

As described above, the present invention enables a flexible multimedia consumption by rendering multimedia contents to a display terminal under a multimedia environment using various user terminals. Thus, unlikes a conventional method for transmitting contents fitted for a fixed standard to a user information terminal and consuming standard contents, by rendering them to a display terminal, it is possible to continuously consume the same contents in any display terminal without being restricted to the limitations such as a specific user's characteristics, display terminal characteristics, user preferences for contents consumption types and user's contents consumption states under a general multimedia access and consumption environment, or consume user's preferred contents in a state optimized for a usage environment.

Moreover, the user's convenience (indicating a general multimedia access) and the mobility of multimedia can be improved and, further, user's various service demands can be effectively satisfied. Furthermore, since the user characteristic information is managed in the user information terminal, there is no additional cost for managing the user information in a server system or a display terminal for a general access. Besides, only necessary information is transmitted from the user information terminal to the display terminal and, therefore, the user information protection can be markedly improved.

While the invention has been shown and described with respect to the preferred embodiments, it will be understood by those skilled in the art that various changes and modification may be made without departing from the spirit and scope of the invention as defined in the following claims.

1. A system for a multimedia consumption based on user terminal characteristics, the system comprising:
a user information terminal for transmitting context metadata created by a user's selection to a display for consuming multimedia contents via a network;
a display terminal for parsing the transmitted context metadata, transmitting the parsed metadata to a content server and then receiving, decoding and displaying the multimedia contents adapted in response to the transmission; and
a content server system for creating adaptation contents by adapting original contents based on the received metadata and then transmitting the created adaptation contents via a network.

2. The system of claim 1, wherein the user information terminal further includes:
a user interface for interfacing control instructions for consuming multimedia contents provided from a user;
a system control module for controlling a movement of the control instructions;
a content control data and context metadata creation, renewal, management and storage block for storing context metadata obtained by analyzing a user history and consumed contents cumulated for the control instructions and then extracting and providing the stored context metadata in case there is a user's request;
a content control data and context metadata transmission block for transmitting the context metadata via a network; and
a context metadata reception block for receiving metadata for consuming adaptation contents from the display terminal via the network.

3. The system of claim 1, wherein the display terminal further includes:
a context metadata reception block for receiving content control data and context metadata;
a context control data and context metadata parsing block for analyzing the received context metadata and providing context metadata containing metadata for characteristics of the display terminal;
a context metadata creation and management block for storing and managing the context metadata and providing the stored context metadata if necessary;
a context metadata transmission block for modulating the context metadata into wired/wirelessly transmittable signals and then transmitting the signals;
an adaptation content reception block for receiving adaptation contents transmitted from the content server system via a network;
an adaptation content decoding block for reversing the received adaptation contents into original contents before the modulation and then providing the reversed adaptation contents;
an adaptation content presentation block for rendering the adapted adaptation contents to allow the user to watch the adaptation contents; and
a content control block for rendering the received content control information as controlled contents.

4. The system of claim 3, wherein the context metadata is information on a user's profile, a user's preference, watched contents consumption records, contents consumption states, user environment characteristics and contents information.

5. The system of claim 3, wherein the context metadata creation and management block stores and manages metadata containing information on a user terminal, which is provided from a terminal characteristic input block, and then extracts and provides, in case specific contents are requested from the user information terminal, context metadata corresponding to the request.

6. The system of claim 3, wherein the context metadata creation and management block provides adaptation contents received from the adaptation contents reception block to the context metadata transmission block.

7. The system of claim 6, wherein the context metadata transmission block provides metadata of adaptation contents received from the context metadata creation and management block to the user information terminal via a network.

8. The system of claim 1, wherein the content server system further includes:
a content archiving block for storing contents and then reading, storing and renewing the stored contents;
a context metadata reception block for receiving context metadata from the display terminal;
a context metadata parsing block for analyzing the provided context metadata and then providing the analysis result;
a content adaptation block for extracting contents requested by the user from the content archiving block in response to the analysis result and providing adaptation contents obtained by transforming contents in accordance with context information; and
an adaptation content transmission and network resource monitoring block for modulating the adapted contents into wired/wirelessly transmittable signal data and then transmitting the signal data to a display terminal.

9. The system of claim 8, wherein the content adaptation block creates transformed contents from original contents by considering user characteristics, bandwidth resources of a network, display terminal characteristic information, consumption records for contents requested by a user and limitation of computing resources.

10. The system of claim 9, wherein the user characteristics includes a user's preference for contents, such as genres, performers, channels, watching hours, personal profiles, consumption prices of watched contents, main time slots of a contents consumption, contents consumption types or the likes and, further, refers to content consumption history and consumption status information.

11. The system of claim 9, wherein the display terminal characteristic information represents characteristic information on the bandwidth of a network to which the display terminal for displaying contents is connected, the number of users of the network, a display terminal size, a color depth, codec characteristics, a battery life, an operating system and a program execution environment.

12. The system of claim 10, wherein the user characteristics are context metadata stored in the user information terminal to allow a content user to constantly consume contents being consumed in another terminal, the context metadata indicating information on identification numbers and titles of contents being consumed, consumption degrees, contents consumption prices, contents consumption types or the likes.

13. The system of claim 10, wherein the user characteristics includes context metadata transmitted to the display terminal for consuming multimedia contents to allow the content user to seamlessly consume contents being consumed in another terminal, the context metadata indicating information on a display terminal in which the user desires to consume contents, such as a display size, a color depth, codec characteristics, characteristics of a power supply system (a battery life, a normal power supply connection or disconnection), a network environment, an execution environment of an operating system.

14. The system of claim 13, wherein the context metadata is transmitted to a new display terminal wired or wirelessly (Bluetooth, Infrared, Mobile networks, Adhoc networks, WLAN (wireless local area network), WPAN (wireless personal area network)).

15. The system of claim 1, wherein the user information terminal and the display terminal selected by the user are wired or wireless terminals, and the network is a wired network including Internet or a wire/wireless network including Internet, Bluetooth, Infrared, Mobile networks, Adhoc networks, WLAN, WPAN.

16. A method for a multimedia consumption based on user terminal characteristics, the method comprising the steps of:
(a) transmitting context metadata created by a user's selection to a terminal for consuming multimedia contents via a network;
(b) parsing the transmitted context metadata and then transmitting the request data and context metadata to a content server;
(c) creating adaptation contents by adapting original contents based on the transmitted metadata and then transmitting the created adaptation contents via a network; and
(d) receiving the adapted multimedia contents and then decoding and displaying the received multimedia contents.

17. The method of claim 16, wherein the step (a) includes the steps of:
interfacing and providing control instructions for consuming multimedia contents provided from the user;
storing context metadata obtained by analyzing a user history cumulated for the control instructions and then extracting and providing the stored context metadata in case there is a user's request; and
transmitting the context metadata via a network and receiving adaptation contents via the network.

18. The method of claim 16, wherein the step (b) includes the steps of:
receiving context metadata from a user information terminal;
analyzing the received context metadata and providing context metadata containing metadata for characteristics of the display terminal; and
storing and managing the context metadata, modulating the stored context metadata into wired/wirelessly transmittable signals and transmitting the signals if necessary.

19. The method of claim 18, wherein the step (b) further includes the steps of:
receiving adaptation contents from a content server system via a network;
reversing the received adaptation contents into original contents before the modulation and then providing the reversed adaptation contents; and
rendering the adapted adaptation contents to allow a user to watch the adaptation contents.

20. The method of claim 18, wherein the context metadata represents information on a user's profile, a user's preference, watched contents consumption records, contents consumption states and user environment characteristics.

21. The method of claim 16, wherein the step (C) includes the steps of:
receiving context metadata from a display terminal;
analyzing the provided context metadata and then providing the analysis result;
extracting contents requested by the user in response to the analysis result and providing adaptation contents obtained by transforming contents in accordance with context information; and
modulating the adapted contents into wired/wirelessly transmittable signal data and then transmitting the signal data to the display terminal.

22. A recording medium for recording a program for implementing one of the methods of claim 16.
